(19) United States
(12) Patent Application Publication
(10) Pub. No.: US 2020/0104972 A1
(43) Pub. Date: Apr. 2, 2020

(54) IMAGE PROCESSING DEVICE, TERMINAL APPARATUS, AND IMAGE PROCESSING PROGRAM

(71) Applicant: SHARP KABUSHIKI KAISHA, Sakai City, Osaka (JP)

(72) Inventors: RYUHJI KITAURA, Sakai City, Osaka (JP); KEI TOKUI, Sakai City, Osaka (JP)

(21) Appl. No.: 16/604,792

(22) PCT Filed: Dec. 19, 2017
(86) PCT No.: PCT/JP2017/045563

§ 371 Date: Oct. 11, 2019

(30) Foreign Application Priority Data
Apr. 14, 2017 (JP) 2017-080426

(51) Int. Cl. G06T 1/20; G06T 3/40; G06T 1/60

(52) U.S. Cl. CPC G06T 1/20; G06T 5/50; G06T 1/60; G06T 3/40

(57) ABSTRACT

An image that is not useful is suppressed from being output. An image processing device (1) includes: a composition corrector (2) configured to output, based on an input image, an output image with a composition according to the input image, in which the composition corrector (2) determines, in accordance with the input image, whether to output the output image, and in a case that the composition corrector (2) outputs the output image, at least one of a change in size, a translation amount, and a rotation amount in a correction from the input image to the output image is equal to or greater than a threshold.

### TECHNICAL FIELD

One aspect of the present invention relates to an image processing device, a terminal apparatus, and an image processing program.

### BACKGROUND ART

Techniques are known in which a portion of an imaged image is cut out to correct a composition so that the composition of the imaged image is optimized, and the image with the corrected composition is stored. Patent Literature 1 discloses a technique for extracting a composition area in which an imaging object is arranged at a preferred position in accordance with logic for multiple compositions such as a rule of thirds, a rule of triangle, and the like and storing the extracted image.

### CITATION LIST

### Patent Literature

PTL 1: JP 2008-92046 A (published on Apr. 17, 2008)

### SUMMARY OF INVENTION

### Technical Problem

However, the technique described above generates an image that is extremely similar to the input image in a case that the correction amount in correcting the composition is minute. In this case, a user who has viewed the generated image cannot feel an effect of correcting the composition. In addition, in a case that the number of pixels in the generated image is the same as the number of pixels in the input image, since the cut-out image is magnified, the resolution is reduced and the image quality is degraded. In addition, in a case of storing the generated image, since the image of which quality is degraded and which is similar to the input image is stored, a storage area is consumed wastefully.

One aspect of the present invention is directed to suppressing an image that is not useful from being output.

### Solution to Problem

In order to solve the above-described problem, an image processing device according to one aspect of the present invention includes: a composition corrector configured to output, based on an input image, an output image with a composition according to the input image, in which the composition corrector determines, in accordance with the input image, whether to output the output image, and in a case that the composition corrector outputs the output image, at least one of a change in size, a translation amount, and a rotation amount in a correction from the input image to the output image is equal to or greater than a threshold.

### Advantageous Effects of Invention

According to one aspect of the present invention, it is possible to suppress an image that is not useful from being output.

### BRIEF DESCRIPTION OF DRAWINGS

FIG. 1 is a block diagram illustrating a schematic configuration example of an image processing device 1 according to a first embodiment of the present invention.

FIG. 2 is a diagram illustrating an example of a case that an output image is generated from an input image.

FIG. 3 is a diagram illustrating an example of a symmetry composition.

FIG. 4 is a diagram illustrating an example of a rule of thirds composition.

FIG. 5 is a diagram illustrating an example of a centered composition.

FIG. 6 is a diagram illustrating an example of a diagonal line composition.

FIG. 7 is a diagram illustrating an example of a triangular composition.

FIG. 8 is a flowchart for illustrating a flow of processing in the image processing device 1 according to the first embodiment of the present invention.

FIG. 9 is a flowchart for illustrating a flow of processing in an image processing device 10 according to a second embodiment of the present invention.

FIG. 10 is a block diagram illustrating a schematic configuration example of an image imaging device 20 according to a third embodiment of the present invention.

FIG. 11 is a flowchart for illustrating a flow of processing in the image imaging device 20 according to the third embodiment of the present invention.

FIG. 12 is a diagram illustrating an example of a screen displayed by a display unit 22.

FIG. 13 is a block diagram illustrating a schematic configuration example of an image processing device 200 and a terminal apparatus 300 according to a fourth embodiment of the present invention.

### DESCRIPTION OF EMBODIMENTS

A description is given in detail below of embodiments according to the present invention with reference to the accompanying drawings. The accompanying drawings merely illustrate specific embodiments complying with a principle of one aspect of the present invention. These drawings are provided only for understanding one aspect of the present invention and not for construing the present invention in a limited manner. Note that elements illustrated in the accompanying drawings are intentionally illustrated to be exaggerated for deeply understanding one aspect of the present invention, and are different from actual elements in distances therebetween and sizes thereof.

In the following descriptions, in a case that a reference sign assigned to a certain element in a drawing is also assigned to the same element in another drawing, a constitution, function and the like of the same element is the same as the certain element, and thus, a detailed description of the same element is omitted. Moreover, an “image” described below refers to that including both a still image and a video. Further, in a case that a video includes sound information, an “image” also includes the sound information.

### First Embodiment

A first embodiment of the present invention will be described below with reference to the drawings.

### Image Processing Device 1

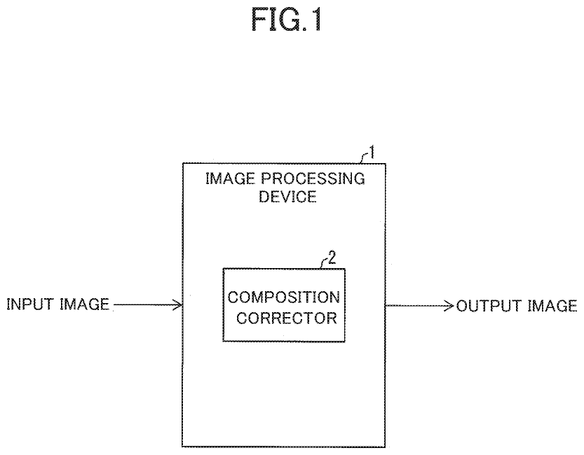

FIG. 1 is a functional block diagram illustrating a configuration of an image processing device 1 according to the first embodiment of the present invention. As illustrated in FIG. 1, the image processing device 1 includes a composition corrector 2.

As illustrated in FIG. 1, to the image processing device 1 according to the present embodiment, image information indicating an input image is input, and the composition corrector 2 outputs, based on the input image, an output image with a composition according to the input image.

The image information to be input includes information on an image imaged by an imaging element, image information recorded in a recording unit (not illustrated), and the like. Output image information to be output is output to an image display device (not illustrated) and displayed, output to the recording unit and recorded, or output to another device.

### Composition Corrector 2

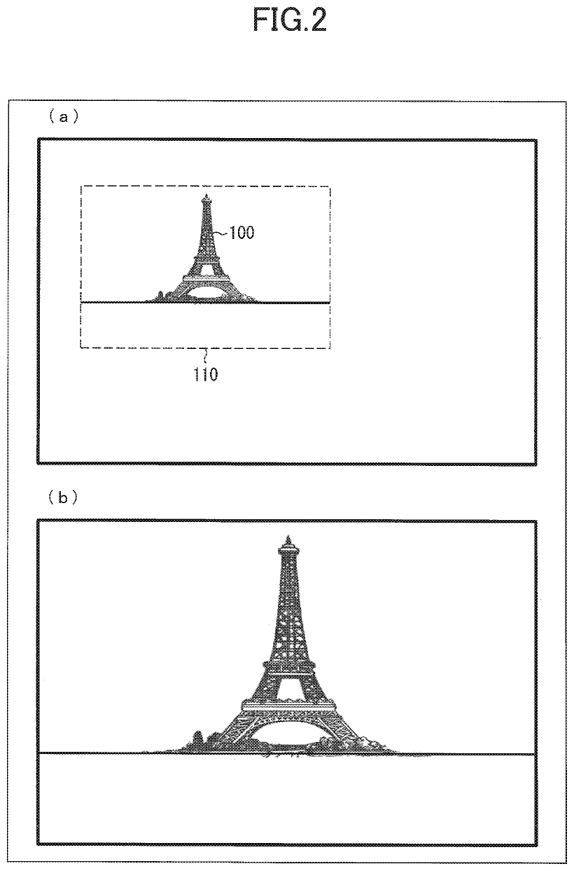

The composition corrector 2 acquires, for example, an input image as illustrated in (a) of FIG. 2. In this case, the composition corrector 2 can output an output image having a composition according to the input image, as illustrated in (b) of FIG. 2, by cutting out an area 110 that is a part of the input image including an imaging object 100 to be noticed. Hereinafter, an operation flow of the composition corrector 2 will be described.

First, the composition corrector 2 performs face detection, feature point extraction, or the like, and extracts information of an imaging object included in the input image. As face detection, for example, extraction of a skin color area in the input image, matching with data indicating facial information, and the like are performed. As the feature point extraction, for example, detection of edges, corners, straight lines, and the like in the image, extraction of a feature amount in the image, and the like are performed. Furthermore, the composition corrector 2 detects a position of the imaging object (for example, the center position of the imaging object).

Next, based on the input image, from multiple compositions to be candidates for the output image, the composition corrector 2 selects a composition of the output image, generates the output image such that the detected face area and feature point are rearranged in the output image in accordance with the selected composition, and outputs the generated image. As the multiple compositions to be the candidates for the output image, a symmetry composition, a rule of thirds composition, a centered composition, a diagonal line composition, and a triangular composition can be cited.

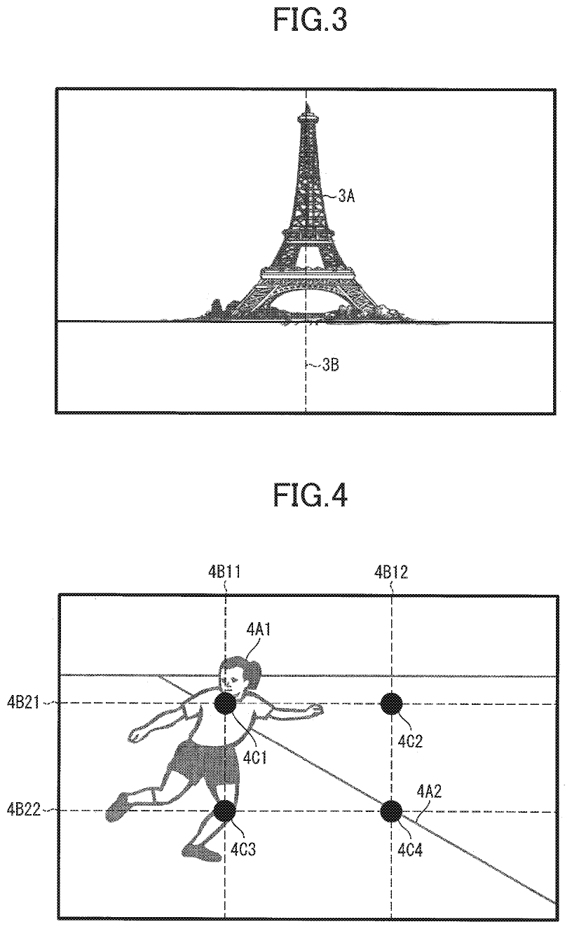

FIG. 3 illustrates an example of the symmetry composition. As illustrated in FIG. 3, the symmetry composition is a composition in which a noticed imaging object 3A is arranged so as to be horizontally symmetrical (or vertically symmetrical) with respect to a center line 3B of the image. In other words, in a case that the symmetry composition is employed as the composition, the area including the calculated feature point is arranged so as to be horizontally symmetrical or vertically symmetrical with respect to the center line of the image.

FIG. 4 illustrates an example of the rule of thirds composition. As illustrated in FIG. 4, the rule of thirds composition is a composition in which, on positions of dividing lines 4B11 and 4B12 that divides an image into three parts in a vertical direction and dividing lines 4B21 and 4B22 that divides the image into three parts in the horizontal direction, and dividing points 4C1, 4C2, 4C3, and 4C4 where the dividing lines 4B11 or 4B12 and 4B21 or 4B22 intersect, noticed imaging objects 4A1 and 4A2 are arranged. In other words, in a case that the rule of thirds composition is employed as the composition, the area including the calculated feature point is arranged on a position of each of the dividing lines and each of the dividing points (the position as described above is referred to as the “position of the arrangement destination of the area including the feature point”).

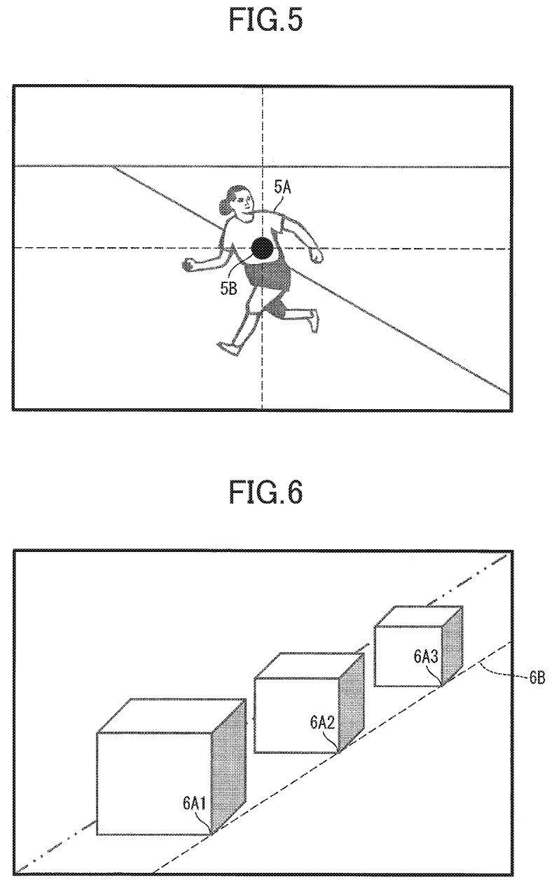

FIG. 5 illustrates an example of the centered composition. As illustrated in FIG. 5, the centered composition is a composition in which a noticed imaging object 5A is arranged at a center 5B of the image. In other words, in a case that the centered composition is employed as the composition, the area including the calculated feature point is arranged at the center of the image (the position of the arrangement destination of the area including the feature point).

FIG. 6 illustrates an example of the diagonal line composition. As illustrated in FIG. 6, the diagonal line composition is a composition in which imaging objects and edges 6A1, 6A2, and 6A3 included in the image are arranged on a line 6B parallel to a diagonal line in the image. In other words, in a case that the diagonal line composition is employed as the composition, an extracted diagonal line is arranged on the diagonal line or arranged so as to be parallel to the diagonal line, in the image.

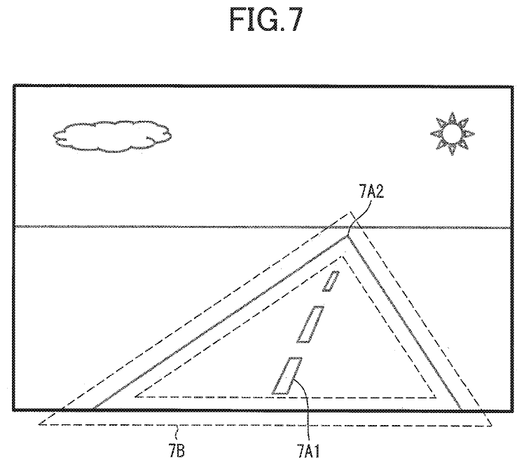

FIG. 7 illustrates an example of the triangular composition. As illustrated in FIG. 7, the triangular composition is a composition in which an imaging object 7A1 and an edge 7A2 included in the image are arranged on a triangle 7B. In other words, in a case that the triangular composition is employed as the composition, the extracted feature point and line are arranged so as to form a triangle in the image.

The composition corrector 2 selects a composition of the output image from the above-described multiple compositions to be the candidates for the output image.

The composition corrector 2 selects the composition of the output image, for example, by calculating a composition score. In a case that the composition is the symmetry composition, the composition corrector 2 calculates the score by matching of a degree of the horizontal symmetry or the vertical symmetry with respect to the center line of the image. Additionally, in a case that the composition is the rule of thirds composition or the centered composition, the composition corrector 2 calculates the score by calculating a distance between the position of the arrangement destination of the area including the feature point and the position of the feature point and the number of feature points. Additionally, in a case that the composition is the diagonal line composition, the composition corrector 2 calculates score by calculating a length of a straight line taken as the diagonal line and the number of edges on the straight line. Then, the composition corrector 2 compares the calculated scores, and selects a composition with the maximum score value from the multiple assumed compositions.

In addition, the composition corrector 2 may give priority to each of the compositions, compare a threshold configured beforehand and the calculated score with each other in order of high priority, and in a case that the score is greater than the threshold, select the corresponding composition. In this case, the composition corrector 2 determines that it is unsuitable to select a composition with a score that is smaller than the threshold as the composition of the output image, and does not select it. The composition corrector 2 selects another composition, for example, without selecting a composition with a score of 0. In this case, in a case that there are no compositions with the score greater than the threshold, the composition corrector 2 can select a composition with the maximum score. Alternatively, in a case that there are no compositions with the score greater than the threshold, the composition corrector 2 does not output the output image information indicating the output image. Additionally, the composition corrector 2 may configure the threshold of the score for each composition.

The composition corrector 2 calculates a correction amount based on the selected composition and imaging object information of the input image, and outputs the output image in which the composition is corrected based on the calculated correction amount.

In one aspect, the composition corrector 2 generates the output image by performing, on the input image, at least one of cut-out defined by a translation amount and a range (size) and rotation defined by a rotation amount. For example, in a case that the cut-out area 110 is cut out from the input image as illustrated in (a) of FIG. 2, the translation amount indicates a vector from a base point of the input image (for example, a point of an upper left corner) to a base point of the cut-out area (for example, a point of an upper left corner). In addition, the range (size) indicates a vertical width and a horizontal width of the cut-out area 110. In addition, in a case that the output image is generated by rotating the input image or an image that is cut out from the input image, the rotation amount indicates a rotation angle from the input image to the output image.

The composition corrector 2 calculates the correction amount (translation amount, range (size), and rotation amount) based on the selected composition and the imaging object information of the input image. For example, in a case that the symmetry composition is selected, the composition corrector 2 may calculate the translation amount and the range in accordance with the position of the center line of the input image, and calculate the rotation amount in accordance with a tilt of the center line of the input image. Additionally, in a case that the rule of thirds composition or the centered composition is selected, the composition corrector 2 may calculate the translation amount and the range in accordance with the position of the imaging object of the input image. Additionally, in a case that the diagonal line composition is selected, the composition corrector 2 may calculate the translation amount and the range in accordance with the position of the diagonal line of the input image, and calculate the rotation amount in accordance with a tilt of the diagonal line of the input image.

Incidentally, in a case that the correction amount is small, the input image and the output image are similar to each other. For example, in a case that the correction amount is such that the rotation amount is zero degrees, the translation amount is one pixel in the vertical direction, and the range is a range that is smaller by one pixel in the vertical direction than the input image, since the output image is an image obtained by cutting off pixels of a first row of the input image, the input image and the output image are extremely similar to each other.

Therefore, the image processing device 1 according to the present embodiment does not output the output image, in a case that the correction amount is small, so as not to output the output image similar to the input image. For example, the composition corrector 2 refers to the correction amount of the selected composition, and in a case that the value of the correction amount is small, does not output the output image in which the composition is corrected. The magnitude of the correction amount is determined by comparing with a predetermined threshold. For example, in a case that the threshold of the rotation amount is configured to one degree, in a case that the rotation amount included in the correction amount is less than one degree, the output image is not output. The threshold is configured for each element, such as the rotation amount, the translation amount, and a change amount in the range (size). The threshold may be configured for all elements or may be configured for some elements.

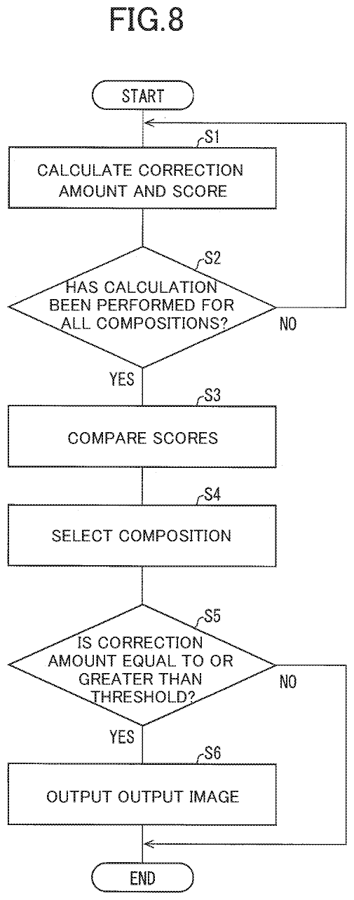

FIG. 8 is a flowchart illustrating an example of a flow of an image processing method performed by the image processing device 1 according to the present embodiment. In a case that image information is input to the image processing device 1, the image processing device 1 starts processing.

The composition corrector 2 calculates the correction amount and the score for each composition, for the input image (S1).

Next, the composition corrector 2 determines whether or not the correction amount and the score have been calculated for all the compositions (S2).

In a case that the calculation processing has not terminated (NO in S2), the processing returns to step S1, and in a case that the calculation processing has terminated (YES in S2), the processing proceeds to step S3.

The composition corrector 2 compares scores of the respective compositions (S3), and the composition corrector 2 selects the composition of the output image (S4).

Next, the composition corrector 2 determines whether or not to output the output image by comparing the correction amount for generating the output image of the selected composition and the threshold configured beforehand (S5).

In a case that the correction amount is less than the threshold (NO in S5), the composition corrector 2 terminates the processing without outputting the generated output image. At this time, the composition corrector 2 may output the input image as it is. Note that the composition corrector 2 may generate the output image regardless of the correction amount of the selected composition. In other words, the composition corrector 2 may generate the output image in the case that the correction amount is less than the threshold as well (NO in S5), but does not output the generated output image.

In a case that the correction amount is equal to or greater than the threshold (YES in S5), the composition corrector 2 generates the output image with the selected composition, outputs only the output image or both the input image and the output image (S6), and terminates the processing.

Whether the composition corrector 2 outputs only the output image or outputs both the input image and the output image can be switched by the configuration of the image processing device 1.

Here, the threshold of the correction amount can be commonly configured for each of the compositions, or can also be individually configured for each of the compositions. Additionally, the threshold of the correction amount can also be configured for one of the elements such as the rotation amount, the translation amount, the range, and the like, or the thresholds can be configured for multiple elements of the elements. In a case that thresholds are configured for the multiple elements, two kinds of processing can be considered. In a case that the threshold is configured for each of the rotation amount and the translation amount, the first processing is processing in which the output image is not generated in a case that any one of the correction amounts is less than the threshold. The second processing is processing in which the output image is not generated in a case that both of the correction amounts are less than the threshold. In a case that the first processing is used, the output image is output in a case of an image with a larger change in the composition. In any case, as a result, the output image output by the composition corrector 2 becomes an image with at least one of the change in size, the translation amount, and the rotation amount in the correction from the input image to the output image being equal to or greater than the threshold.

Furthermore, the threshold of the correction amount may be configurable as desired by specification from the outside of the image processing device 1, such as user's specification. Depending on the user, the feeling for the effect of the composition correction varies. Therefore, in a case that the threshold of the correction amount can be arbitrarily configured, processing according to the user can be performed.

Furthermore, in general, the larger the size of a screen that displays the corrected image is, the greater the effect of the correction is. Accordingly, in a case of displaying on a large screen such as a television, the effect of the correction also increases. In this way, in a case that the threshold of the correction amount is configured by the external input, processing suitable for an expected display size can be performed.

Furthermore, the composition corrector 2 can correspond to a change in the composition in consideration of all of the elements of the correction amount by configuring not only one combination but also multiple combinations of the thresholds of the correction amount. In a case that the threshold of a prescribed element included in the correction amount is configured to be large, the threshold of another element included in the correction amount may be reduced. For example, multiple conditions can be configured such that, in a case that the threshold of the rotation amount is one degree, the threshold of the translation amount is configured to 100 pixels, and in a case that the threshold of the rotation amount is two degrees, the threshold of the translation amount is configured to 80 pixels, or the like. As a result, it is possible to control whether or not to output the output image by the change amount in the final composition taking into account all of the elements of the correction amount.

Additionally, in a case that a value of any element of the correction amount is less than the threshold, the composition corrector 2 can configure the value of the element less than the threshold to 0, and correct the composition without changing the values of the remaining elements. As a result, the correction can be performed only for elements that have the effect of the correction, and degradation in the image can be suppressed. For example, in a case that the threshold of the rotation amount is configured to 1 degree and the threshold of the translation amount is configured to 100 pixels, in a case that the rotation amount is 0.5 degrees and the translation amount is 200 pixels, the composition corrector 2 may perform a correction of zero degrees in the rotation amount and 200 pixels in the translation amount.

As described above, the composition corrector 2 may separately output the input image even in any case of a case of outputting and a case of not outputting the output image in which the composition is corrected. With this, in a case that the imaged image is an image that does not match any of the respective compositions, in a case that there is an error in the determination of the composition, in a case that the user does not like the corrected composition, and the like, the user can also utilize the input image before the correction. In addition, in a case that the output image in which the composition is corrected is output, particularly, the correction result can also be confirmed by comparing the images before and after the correction.

As described above, in the present embodiment, in a case that the difference between the input image and the output image is small, that is, in a case that the correction amount is small, the composition corrector 2 does not output the output image. This makes it possible to output the output image only in a case that it is expected that an image for which the user will be able to feel the effect can be output. Accordingly, it becomes less frequently that the user does not feel the effect of the correction. Furthermore, the storage area can be suppressed from being reduced due to the storage of similar images. In addition, it is possible to suppress an image degraded in image quality from being output.

### Second Embodiment

A second embodiment of the present invention will be described.

### Composition Corrector 2

The composition corrector 2 according to the present embodiment compares the correction amount and the threshold not only for the selected composition but also for other compositions. Hereinafter, only an operation of comparing the correction amount and the threshold for each of the compositions will be described.

In a case that the correction amount of the selected composition is smaller than the threshold, the composition corrector 2 does not output the output image corrected to have the selected composition. Then, for another composition different from the selected composition, the correction amount and the threshold are compared, and in a case that the correction amount is equal to or greater than the threshold, the output image resulting from correcting the composition of the input image to the other composition is output.

For example, in a case that the composition corrector 2 selects the composition of the output image from among multiple compositions including the symmetry composition, in a case that the correction amount for generating the output image with the symmetry composition is smaller than the threshold, another composition different from the symmetry composition is selected. Note that for all compositions, in a case that the correction value for generating the output image is smaller than the threshold configured beforehand, the output image is not output.

### General Processing Flow

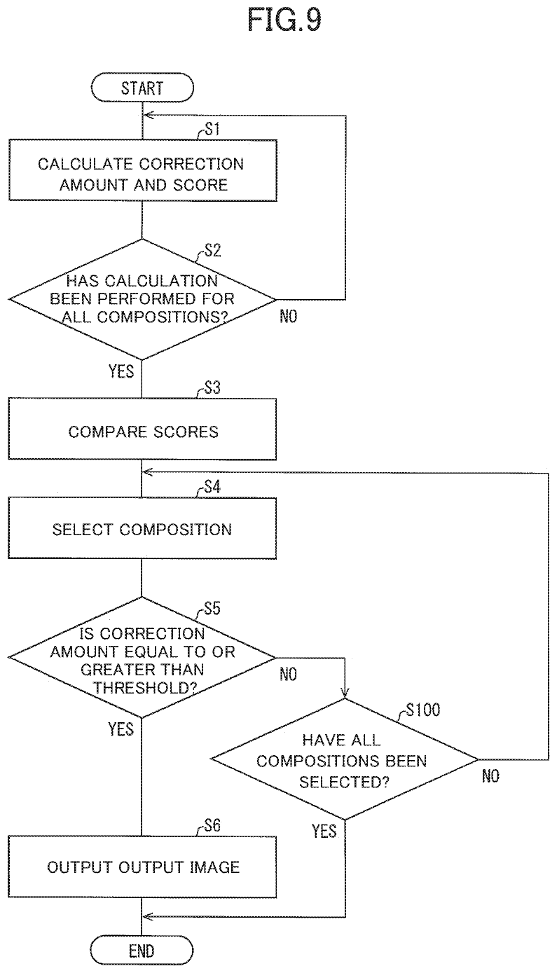

FIG. 9 is a flowchart illustrating a flow of an image processing method performed by an image processing device 10 according to the present embodiment.

The flowchart in FIG. 9 differs from the flowchart in FIG. 8 in a point that step S100 is added. Thus, only the processing relating to step S100 will be described.

In the present embodiment, in step S4, the composition corrector 2 selects a composition from compositions that have not yet selected.

The composition corrector 2 determines whether or not the composition determined that the correction amount is equal to or smaller than the threshold in step S5 is the last composition (step S100).

In a case of the last composition (YES in step S100), the processing terminates without outputting the output image. In a case of not being the last composition (NO in step S100), the processing returns to step S4.

By the processing described above, in a case that the correction amount for generating the output image with the selected composition is smaller than the configured threshold, the other composition different from the selected composition is reselected, and in a case that the correction amount for generating the output image with the reselected other composition is greater than the configured threshold, an output image that is corrected to have the reselected other composition is output. In other words, the composition corrector 2 selects the composition of the output image such that at least one of the change in size, the translation amount, and the rotation amount in the correction from the input image to the output image is equal to or greater than the threshold. As a result, the output image, which is not similar to the input image, that allows the user to easily feel the effect of the composition correction can be output. Additionally, in a case that the correction amount of the reselected other composition is smaller than the configured threshold, the output image according to the composition is not output. Furthermore, in a case that the correction amounts of all the compositions are smaller than the thresholds respectively configured for the compositions, the output image is not output. As a result, the output image with the composition with small correction effect, that is, the output image similar to the input image is not output.

Furthermore, the composition corrector 2 can target only a composition in which the composition score is equal to or greater than the prescribed score threshold, as the other composition to be reselected described above. As a result, the output image corrected to have an unsuitable composition as the composition is not output.

Note that, in the multiple compositions, in a case that the correction amount for generating the output image with each composition is greater than the threshold and it is determined that the correction effect is obtained, for each composition having the large correction amount for generating the output image, the output image corrected to the composition may be output.

### Third Embodiment

An image imaging device according to a third embodiment of the present invention will be described.

### Image Imaging Device 20

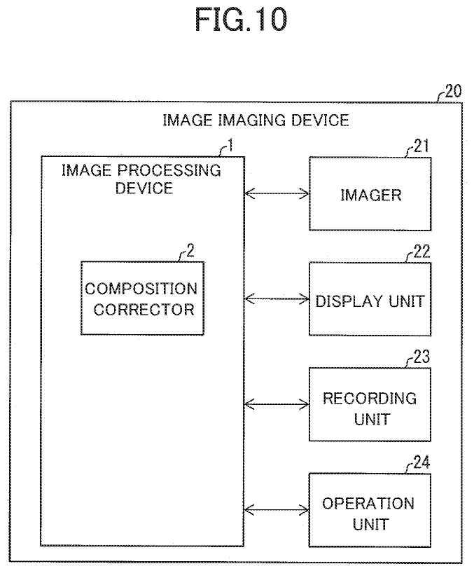

An image imaging device 20 according to the third embodiment includes the image processing device according to the first embodiment or the second embodiment. As illustrated in FIG. 10, the image imaging device 20 includes the image processing device 1, an imager 21, a display unit 22, a recording unit 23, and an operation unit (input unit) 24. The image imaging device 20 uses an image acquired by the imager 21 to output an output image with a composition corrected by the image processing device 1, the display unit 22 displays the output image, the operation unit 24 is operated, and in a case that the image is selected, the recording unit 23 records image information indicating the image.

### Imager 21

The imager 21 includes an imaging lens and an imaging element such as a Charge Coupled Device (CCD), a Complementary Metal Oxide Semiconductor (CMOS) sensor, or the like. The imager 21 images an imaging object and generates an image (still image or video) including the imaging object.

### Display Unit 22

The display unit 22 is a display screen such as a Liquid Crystal Display (LCD), an organic Electro Luminescence (EL) display, or the like. The display unit 22 displays information such as images, characters, and the like, an image of an imaging object, and the like.

### Recording Unit 23

The recording unit 23 records image information indicating the image in a storage medium. Furthermore, the recording unit 23 reads the image information recorded in the storage medium and outputs the information to the image processing device 1. The recording unit 23 is constituted of a flash memory, a hard disk, or the like.

### Operation Unit 24

The operation unit 24 accepts an operation input by the user. The operation unit 24 is not particularly limited as long as the user can perform a desired operation input.

The image processing device 1 performs the same operation as that described in the first embodiment.

### General Processing Flow

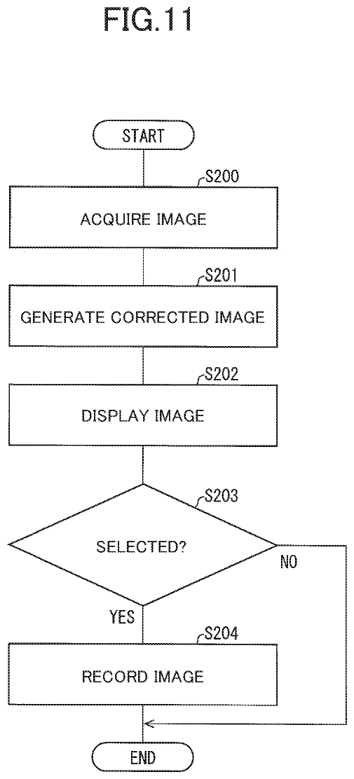

Operations of the image imaging device 20 according to the present embodiment will be described with reference to a flowchart illustrated in FIG. 11.

As processing for acquiring the image, the imager 21 images the image. Alternatively, the recording unit 23 reads the image information. Then, the image processing device 1 acquires the image information indicating the image imaged by the imager 21 or the image information read by the recording unit 23 (S200).

The image processing device 1 performs, on the input image indicated by the acquired image information, the same processing as the composition corrector 2 of the image processing device 1 according to the first embodiment or the second embodiment. Specifically, the image processing device 1 performs processing for correcting the composition, and outputs the output image that is not similar to the input image in a case that the correction amount is equal to or greater than the configured threshold (S201). Note that in the case that the correction amount is smaller than the configured threshold in each of all the compositions, the image processing device 1 does not output the output image.

In a case that the output image whose composition is corrected is output, the display unit 22 displays the output image output from the image processing device 1 (S202).

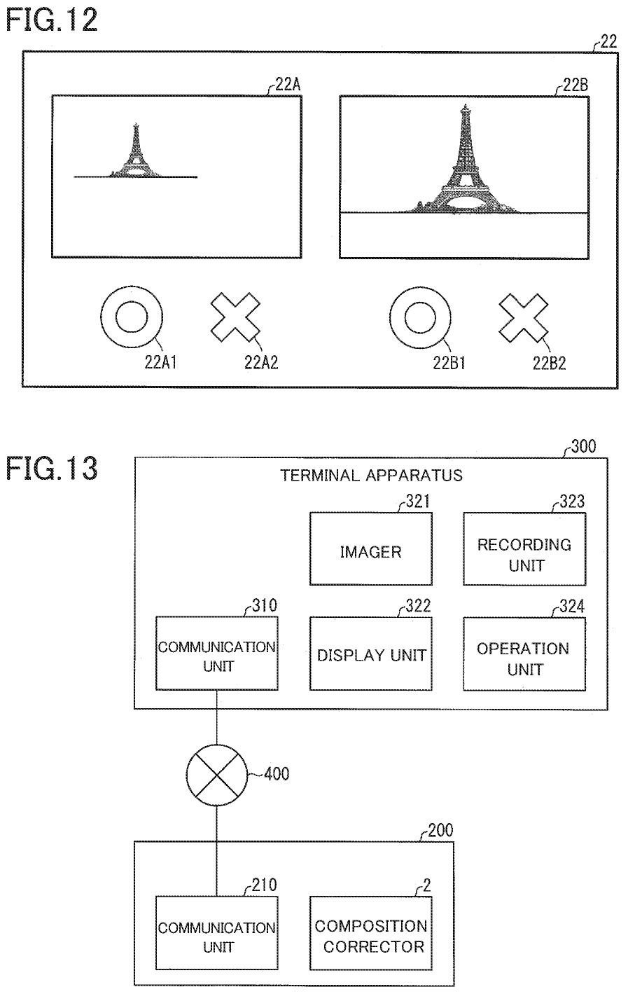

FIG. 12 illustrates a display example of the display unit 22. As illustrated in FIG. 12, the display unit 22 displays an input image 22A before correcting the composition along with an output image 22B. Furthermore, the display unit 22 displays objects 22B1 and 22B2 indicating whether or not to select to record the output image below the output image 22B. In the same manner, the display unit 22 displays objects 22A1 and 22A2 indicating whether or not to select to record the input image below the input image 22A.

The recording unit 23 determines whether or not the operation unit 24 has accepted the operation on the objects 22A1 and 22B1 (input as to whether or not to record the input image or the output image in the recording unit 23) (S203). In a case that at least one of the output image and the input image is selected (YES in S203), the processing proceeds to S204. In a case that neither the output image nor the input image is selected (NO in S203), the processing terminates.

In a case that the output image is selected, the recording unit 23 records the output image information indicating the output image acquired from the image processing device 1 in a recording medium. Furthermore, in a case that the input image is selected, the recording unit 23 records input image information indicating the input image in the recording medium (S204).

By the processing described above, in a case that the correction amount of the composition is small, without outputting the output image resulting from correcting the composition of the input image, the image imaging device 20 can select whether or not to record the output image in the recording unit 23. This makes it possible to output and display or record the output image in a case that it is expected that an image for which the user will be able to feel the effect of the composition correction can be generated. Furthermore, the storage area can be suppressed from being reduced due to storing similar images.

Note that S203 may be skipped and the recording unit 23 may record all of the output images.

Furthermore, the recording unit 23 may configure beforehand which image is to be output, and record the output image in accordance with the configuration.

### Fourth Embodiment

An image processing device and a terminal apparatus according to a fourth embodiment of the present invention will be described. As illustrated in FIG. 13, an image processing device 200 and a terminal apparatus 300 communicate with each other via a network 400.

### Image Processing Device 200

The image processing device 200 according to the fourth embodiment includes the composition corrector 2 according to the first embodiment or the second embodiment and a communication unit 210.

### Terminal Apparatus 300

The terminal apparatus 300 includes a communication unit 310, an imager 321, a display unit 322, a recording unit 323, and an operation unit 324.

The imager 321, the display unit 322, the recording unit 323, and the operation unit 324 correspond to the imager 21, the display unit 22, the recording unit 23, and the operation unit 24, respectively, of the image imaging device 20 according to the third embodiment.

The communication unit 310 communicates with the communication unit 210 of the image processing device 200 via the network 400. The communication unit 310 transmits the image imaged by the imager 321 or the image recorded by the recording unit 323, as the input image, to the image processing device 200.

The image processing device 200 performs, in a case of receiving the input image transmitted by the terminal apparatus 300 via the communication unit 210, the processing illustrated in FIG. 8 or FIG. 9.

Furthermore, the terminal apparatus 300 performs, in a case of receiving the output image output by the image processing device 200 via the communication unit 310, the processing indicated in S201 to S204 in FIG. 11.

### Implementation Examples by Software

The control block (composition corrector 2) of the image processing device 1 may be achieved by a logic circuit (hardware) formed as an Application Specific Integrated Circuit (ASIC), a Field Programmable Gate Array (FPGA), an integrated circuit (IC chip), or the like, or may be achieved by software using a Central Processing Unit (CPU) and a Graphics Processing Unit (GPU).

In the latter case, the image processing device 1 includes a CPU performing instructions of a program that is software implementing the functions, a Read Only Memory (ROM) or a storage device (these are referred to as recording media) in which the program and various data are stored to be readable by a computer (or CPU), a Random Access Memory (RAM) in which the program is deployed, and the like. The computer (or CPU) reads from the recording medium and performs the program to achieve the object of one aspect of the present invention. As the above-described recording medium, a “non-transitory tangible medium” such as a tape, a disk, a card, a semiconductor memory, and a programmable logic circuit can be used. The program may be supplied via any transmission medium capable of transmitting the program (communication network, broadcast waves, etc.) to the computer. Note that one aspect of the present invention may also be implemented in a form of a data signal embedded in a carrier wave in which the program is embodied by electronic transmission. The “computer” here includes an OS and hardware components such as a peripheral device. Further, the computer includes environment for supplying a home page (or environment for display) in a case of utilizing a WWW system.

### Supplement

An image processing device 1 according to Aspect 1 of the present invention includes: a composition corrector configured to output, based on an input image, an output image with a composition according to the input image, in which the composition corrector determines, in accordance with the input image, whether to output the output image, and in a case that the composition corrector outputs the output image, at least one of a change in size, a translation amount, and a rotation amount in a correction from the input image to the output image is equal to or greater than a threshold.

According to the above-described configuration, it is possible to suppress an image that is not useful from being output.

In the image processing device 1 according to Aspect 2 of the present invention, in Aspect 1 described above, in a case that the composition corrector 2 does not output the output image, the composition corrector 2 may output the input image.

According to the above-described configuration, in a case that the imaged image is an image that does not match any of the respective compositions, in a case that there is an error in the determination of the composition, in a case that the user does not like the corrected composition, and the like, the user can also utilize the input image before the correction.

In the image processing device 1 according to Aspect 3 of the present invention, in Aspect 1 or 2 described above, in a case that the composition corrector 2 outputs the output image, the composition corrector 2 may further output the input image.

According to the above-described configuration, the correction result can be confirmed by comparing the images before and after the correction.

In the image processing device 1 according to Aspect 4 of the present invention, in one aspect of Aspects 1 to 3 described above, the composition corrector may select, based on the input image, the composition of the output image from a plurality of compositions.

According to the above-described configuration, the composition can be suitably selected.

An image processing device 1 according to Aspect 5 of the present invention includes: a composition corrector configured to output, based on an input image, an output image with a composition according to the input image, in which the composition corrector selects, based on the input image, the composition of the output image from a plurality of compositions, and the composition corrector may select the composition of the output image such that at least one of a change in size, a translation amount, and a rotation amount in a correction from the input image to the output image is equal to or greater than a threshold.

According to the above-described configuration, it is possible to suppress an image that is not useful from being output.

The image processing device 1 according to Aspect 6 of the present invention, in one aspect of Aspects 1 to 5 described above, the image processing device 1 may further include: an input unit (operation unit 24) configured to accept an input as to whether to record the output image; and a recording unit 23 configured to record the output image output by the composition corrector in accordance with the input to the input unit.

According to the above-described configuration, a user can select whether or not the output image is recorded by the recording unit. This makes it possible to further suppress the image that is not useful from being recorded.

An image processing device 200 according to Aspect 7 of the present invention, in one aspect of Aspects 1 to 6 described above, the image processing device 200 further includes: a first communication unit (communication unit 210) configured to receive the input image from a terminal apparatus 300 and transmit the output image output by the composition corrector to the terminal apparatus.

A terminal apparatus 300 according to Aspect 8 of the present invention is a terminal apparatus for communicating with the image processing device 200 according to Aspect 7, the terminal apparatus 300 includes: a second communication unit (communication unit 310) configured to transmit the input image to the image processing device and receive the output image from the image processing device.

According to the above-described configuration, by the terminal apparatus and the image processing device communicating with each other, the same effect as that of Aspect 1 can be achieved.

Control of an image processing device according to Aspect 9 of the present invention includes a step of: composition-correcting in which the image processing device outputs, based on an input image, an output image with a composition according to the input image, in which, in the composition-correcting, the image processing device determines, in accordance with the input image, whether to output the output image, and in a case that the image processing device outputs the output image in the composition-correcting, at least one of a change in size, a translation amount, and a rotation amount in a correction from the input image to the output image is equal to or greater than a threshold.

According to the above-described configuration, the same effect as that of Aspect 1 can be achieved.

The image processing device according to each of the aspects of the present invention may be implemented by a computer. In this case, the present invention embraces also an image processing program of the image processing device that implements the above image processing device by a computer by causing the computer to operate as each unit (software element) included in the above image processing device, and a computer-readable recording medium recording the program.

The present invention is not limited to each of the above-described embodiments. It is possible to make various modifications within the scope of the claims. An embodiment obtained by appropriately combining technical elements each disclosed in different embodiments falls also within the technical scope of the present invention. Further, technical elements disclosed in the respective embodiments are combined to form a new technical feature.

### CROSS-REFERENCE OF RELATED APPLICATION

This application claims the benefit of priority to JP 2017-080426 filed on Apr. 14, 2017, which is incorporated herein by reference in its entirety.

### REFERENCE SIGNS LIST

1, 10, 200 Image processing device
2, 11 Composition corrector
20 Image imaging device
21, 321 Imager
22, 322 Display unit
23, 323 Recording unit
24, 324 Operation unit (input unit)
210 Communication unit (first communication unit)
300 Terminal apparatus
310 Communication unit (second communication unit)

1-4. (canceled)

5. An image processing device comprising:
a composition corrector configured to output, based on an input image, an output image with a composition according to the input image,
wherein the composition corrector selects, based on the input image, the composition of the output image from a plurality of compositions, and
the composition corrector selects the composition of the output image such that at least one of a change in size, a translation amount, and a rotation amount in a correction from the input image to the output image is equal to or greater than a threshold.

6. The image processing device according to claim 5, the image processing device further comprising:
an input unit configured to accept an input as to whether to record the output image; and
a recording unit configured to record the output image output by the composition corrector in accordance with the input to the input unit.

7. The image processing device according to claim 5, the image processing device further comprising:
a first communication unit configured to receive the input image from a terminal apparatus and transmit the output image output by the composition corrector to the terminal apparatus.

8. (canceled)

9. A control method of an image processing device, the control method comprising a step of:
composition-correcting in which the image processing device outputs, based on an input image, an output image with a composition according to the input image,
wherein, in the composition-correcting, the image processing device selects, based on the input image, the composition of the output image from a plurality of compositions, and
in the composition-correcting, the image processing device selects the composition of the output image such that at least one of a change in size, a translation amount, and a rotation amount in a correction from the input image to the output image is equal to or greater than a threshold.

10. A non-transitory recording medium containing an image processing program for causing a computer to operate as a composition corrector that outputs, based on an input image, an output image with a composition according to the input image, the composition corrector selecting the composition of the output image such that at least one of a change in size, a translation amount, and a rotation amount in a correction from the input image to the output image is equal to or greater than a threshold.

11. The image processing device according to claim 5,
wherein, in a case that at least one of the change in size, the translation amount, and the rotation amount in the correction from the input image to the output image is equal to or greater than a threshold, the composition corrector outputs the output image with the selected composition.

12. The image processing device according to claim 11,
wherein, in a case that the composition corrector does not output the output image, the composition corrector outputs the input image.

13. The image processing device according to claim 11,
wherein, in a case that the composition corrector outputs the output image, the composition corrector further outputs the input image.
